(19) United States
(12) Patent Application Publication
(10) Pub. No.: US 2008/0105478 A1
(43) Pub. Date: May 8, 2008

(54) Hybrid Vehicle Drive

(76) Inventor: Timothy Bishop, Northants (GB)

Correspondence Address: AMSTER, ROTHSTEIN & EBENSTEIN LLP, 90 PARK AVENUE, NEW YORK, NY, 10016, US

(21) Appl. No.: 11/793,833

(22) PCT Filed: Dec. 22, 2005
(86) PCT No.: PCT/GB05/05024

§ 371 Date: Nov. 28, 2007

(30) Foreign Application Priority Data
Dec. 22, 2004 (GB) 0428085.5

(51) Int. Cl. B60W 20/00; B60W 10/08; B60K 6/00; B60W 10/10

(52) U.S. Cl. 180/65.8; 180/165

(57) ABSTRACT

A hybrid drive system comprising: an internal combustion engine having a first output shaft; an electric motor having a second output shaft coupled to the first output shaft, the motor being capable of operating in a drive mode to drive the second output shaft and in a regeneration mode to generate electricity from the motion of the second output shaft; a gearbox having an input shaft coupled to the first and second output shafts and an output shaft coupleable to the input shaft in any of two or more gear ratios; a control unit arranged to control the electric motor during the changing of the gearbox from one gear ratio to another so as to alter the speed of the input shaft so as to match that of the output shaft for the said other gear ratio.

This invention relates to performing gear changes in hybrid drive systems such as those used for hybrid vehicles.

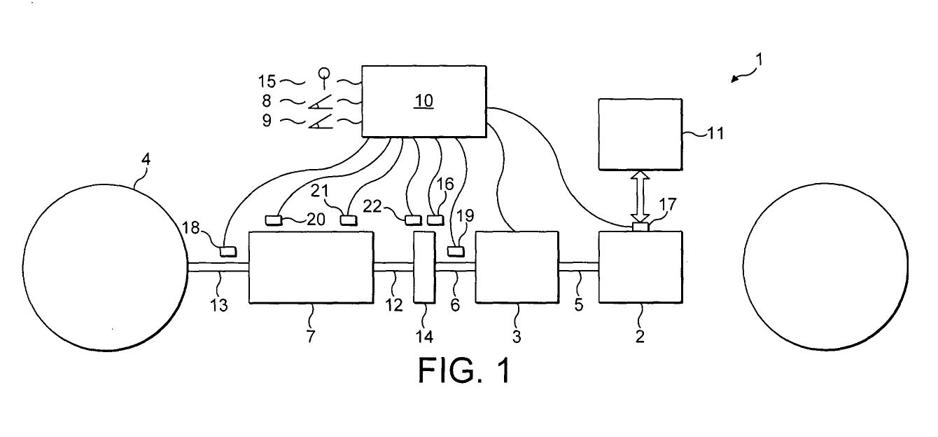

FIG. 1 illustrates schematically the configuration of one type of hybrid vehicle. In the configuration of FIG. 1 the vehicle 1 has an electric motor 2 and an internal combustion engine 3 that can be used to drive the wheels 4. The output shaft 5 of the electric motor 2 is connected by direct or indirect means to the crankshaft 6 of the engine 3, and the crankshaft 6 is connected to the wheels 4 through a clutch 14 and a gearbox 7. The driver can control the vehicle using an accelerator pedal 8 to speed up and a brake pedal 9 to slow down. These pedals provide input to a control unit 10 which controls the power generated by the engine and the operation of motor 2. The motor can either operate in a drive mode by drawing power from a battery 11 to supplement the engine, or it can operate in a regeneration mode to draw power from the vehicle's momentum to recharge the battery.

If the gearbox is an automatic gearbox having a torque converter then the torque converter will help to ensure that the gearshifts are smooth. However, if the gearbox has no torque converter then for the gearshifts to be smooth it is desirable for the driver or the control unit to intervene to match the speed of the engine to the speed of the wheels and the gear that is to be selected. As illustrated in FIG. 1, the gearbox has an input shaft 12 and an output shaft 13. Various gear ratios can be selected for coupling the two shafts. When it is desired to move from one ratio to another the speed of the output shaft will be determined by the speed of the vehicle. During gear changing the speed of the input shaft will be matched by the synchromesh action to that speed at which it will drive the output shaft in the new gear for the vehicle's current speed. However, the unmatched engine speed differential will jerk the vehicle, or will be taken up by slipping the clutch 14. This is particularly significant when the clutch is to be automatically controlled by the vehicle.

For this reason control systems to assist speed matching have been used in vehicles that have automatic or semi-automatic clutches. It is known to use the control system of an internal combustion engine to perform such matching. For example, some gearboxes can provide output to an engine management system to allow automatic speed matching during gear changes. However, such a system has a number of limitations. First, during upshifts the engine has to decelerate between the time when the initial gear is disengaged and the subsequent gear is engaged. The engine can be caused to decelerate by cutting its fuel supply, but the time taken for the engine to decelerate is dependent on its inertia. This extends the time taken for upshifts. Second, energy is wasted when the engine decelerates in this way, reducing the vehicle's efficiency.

There is therefore a need for an improved scheme for speed matching during gear changes.

According to the present invention there is provided a hybrid drive system comprising: an internal combustion engine having a first output shaft; an electric motor having a second output shaft coupled to the first output shaft, the motor being capable of operating in a drive mode to drive the second output shaft and in a regeneration mode to generate electricity from the motion of the second output shaft; a gearbox having an input shaft coupled to the first and second output shafts and an output shaft coupleable to the input shaft in any of two or more gear ratios; a control unit arranged to control the electric motor during the changing of the gearbox from one gear ratio to another so as to alter the speed of the input shaft so as to match that of the output shaft for the said other gear ratio.

Preferably the control unit is arranged to: when the electric motor is not operating in the regeneration mode at the start of the changing of the gearbox from one ratio to the other, and the said other ratio is one for which the speed of the input shaft is lower for a given speed of the third output shaft than in the said one ratio, cause the electric motor to enter the regeneration mode during the changing of the gearbox from one gear ratio to another so as to reduce the speed of the input shaft so as to match that of the output shaft for the said other gear ratio.

Preferably the control unit is arranged to: when the electric motor is not operating in the drive mode at the start of the changing of the gearbox from one ratio to the other, and the said other ratio is one for which the speed of the input shaft is higher for a given speed of the third output shaft than in the said one ratio, cause the electric motor to enter the drive mode during the changing of the gearbox from one gear ratio to another so as to increase the speed of the input shaft so as to match that of the output shaft for the said other gear ratio.

Preferably the gearbox is manually operable to change from one ratio to another.

Preferably the control unit is arranged to, on manual disengagement of one gear ratio, make an estimate of the gear ratio that will be engaged next and to control the electric motor during the changing of the gearbox from one gear ratio to another so as to alter the speed of the input shaft so as to match that of the output shaft for the estimated gear ratio.

Preferably the control unit is capable of automatically operating the gearbox to change from one ratio to another.

The hybrid drive system preferably comprises a clutch for disconnecting the input shaft of the gearbox from the first and second output shafts, and wherein the control unit is capable of automatically operating the clutch to disconnect the input shaft of the gearbox from the first and second output shafts.

Preferably the control unit is arranged to control the power output of the engine during the changing of the gearbox from one gear ratio to another so as to alter the speed of the input shaft so as to match that of the output shaft for the said other gear ratio.

The third output shaft is preferably arranged for propulsion of the vehicle.

The present invention will now be described by way of example with reference to the accompanying drawing.

In the drawing:

FIG. 1 is a schematic diagram of a hybrid vehicle.

The present invention is applicable to a vehicle of the type illustrated in FIG. 1 by modifying the logic used by the control unit 10. In the present invention the motor 2 is controlled by the control unit 10 to assist the matching of the speed ratio of the input and output shafts of the gearbox during gear changes.

During upshifts, after the input shaft of the gearbox has been disengaged from the output shaft, the motor can be used in regeneration (braking) mode to cause the crankshaft of the engine to decelerate. This causes the engine to decelerate more quickly than it would merely as a result of cutting fuel to the engine, reducing the time needed for upshifts, and allows the energy of the engine's inertia to be used to charge the battery 11.

During downshifts, after the input shaft of the gearbox has been disengaged from the output shaft, the motor can be used in drive mode to cause the crankshaft to accelerate, either wholly electrically or as a combined effort. This causes the engine to accelerate more quickly than it would merely as a result of supplying extra fuel to the engine, reducing the time needed for downshifts.

The operation of the vehicle to achieve speed matching will now be described in more detail.

The vehicle has a gearshift lever 15 which the driver can operate to select the gear in which the vehicle is to operate. The gearshift lever could be mechanically connected to the gearbox so as mechanically perform gear selection. Alternatively, it could be an electrical switch that indicates to the control unit 10 which gear is to be selected, in which case the control unit 10 could then automatically operate the gear selection using electrohydraulic actuators 21 (or any other kind of actuator). The clutch could be actuated manually by the driver operating a foot pedal. Alternatively, it could be actuated by the control unit 10 using an electrohydraulic actuator or as above 22 in response to the driver operating a clutch control input switch, which could be located on the gearshift lever 15. In any event, there are preferably sensors 16 whereby the control unit 10 can detect whether the clutch is engaged or disengaged, and sensors 20 whereby the control unit 10 can detect which gear is selected at any time. The description below refers to the example where the gearshift lever is an electrical switch, and the clutch operation is controlled automatically by the control unit 10. In other systems the control unit 10 would sense gear selection and/or the operation of the clutch and operate accordingly.

The motor 2 has a power regulator 17. The power regulator operates under the control of the control unit 10 to set whether the motor operates in drive mode or in regeneration mode, by regulating the flow of current between the motor and the battery 11.

The control unit 10 can control the fuel supply to the engine in the normal way.

In an upshift operation, the user operates the gearshift lever 15 to indicate selection of a higher gear. In response, the control unit 10 begins controlling the equipment of the vehicle to perform the upshift operation. The steps of the upshift operation are as follows:
1. Control unit 10 causes the clutch to be disengaged.
2. Control unit 10 operates the gearbox to disconnect the input and output shafts.
3. Control unit 10 measures the speed of output shaft 13 using speed sensor 18 (or simply looks at road-speed), and calculates the speed of the input shaft that will be required to match the output shaft speed on engagement of the target gear.
4. Control unit 10 measures the speed of input shaft 12 using speed sensor 19, and cuts fuel supply to the engine and causes the motor to operate in regeneration mode so as to retard the engine until the required speed of the input shaft is reached. In regeneration mode the motor is driven by the crankshaft of the engine to store energy in the battery.
5. When the required speed of the input shaft is reached, control unit 10 operates the gearbox to reconnect the input and output shafts in the target gear.
6. Control unit 10 re-engages the clutch.
7. Normal fuel supply to the engine under the control of the driver is resumed.

The operation sequence could be different.

If the gearbox is a synchromesh box the action of shifting gear will cause the declutched input shaft to change to the correct speed as the gear is selected. The speed sensor can transmit this information to the controller, which can then call for the hybrid motor to respond. Then the clutch can be reengaged.

In this operation the speed matching can be performed faster than in prior art systems in which the motor is not used for retardation, and in addition energy can be recovered from the inertia of the engine. It should be noted that the system differs from one in which the motor would happen to be operated in recovery mode throughout the upshift operation due to normal regeneration being in process before and after the shift. In the present operation the retardation from the motor is controlled and/or synchronised with gear selection so as to achieve speed matching.

In an downshift operation, the user operates the gearshift lever 15 to indicate selection of a lower gear. In response, the control unit 10 begins controlling the equipment of the vehicle to perform the downshift operation. The steps of the downshift operation are as follows:
1. Control unit 10 causes the clutch to be disengaged.
2. Control unit 10 operates the gearbox to disconnect the input and output shafts.
3. Control unit 10 measures the speed of output shaft 13 using speed sensor 18, and calculates the speed of the input shaft that will be required to match the output shaft speed on engagement of the target gear.
4. Control unit 10 measures the speed of input shaft 12 using speed sensor 19, and allows fuel supply to the engine and causes the motor to operate in drive mode so as to accelerate the crankshaft of the engine until the required speed of the input shaft is reached.
5. When the required speed of the input shaft is reached, control unit 10 operates the gearbox to reconnect the input and output shafts in the target gear.
6. Control unit 10 re-engages the clutch.
7. Normal fuel supply to the engine under the control of the driver is resumed.

In this operation the speed matching can be performed faster than in prior art systems in which the motor is not used for acceleration; and the acceleration of the engine can be performed more efficiently, especially if it is switched off or operating under low throttle before the shift operation. It should be noted that the system differs from one in which the motor would happen to be operated in drive mode throughout the downshift operation due to normal supplementary drive being in process before and after the shift. In the present operation the drive from the motor is controlled and/or synchronised with gear selection so as to achieve speed matching.

The operation system could be different, as in upshift.

In each case, during step 5 the control unit could either monitor the speed of the input shaft and operate the gearbox in response to the required speed being reached, or could estimate the amount of time required for the required speed to be achieved and engage the target gear after that time. The control unit could further monitor temperatures of the engine and the transmission to allow for viscosity differences caused by temperature of the fluids, although this is not essential.

The system could be predictive in that the gear lever position, rate of change of gear lever, clutch pedal position/rate of change thereof and vehicle road speed can be used to predict the next selected gear thus allowing the rotational speeds to be matched earlier and allowing for faster gear changes.

It should be noted that allowing the vehicle to operate automatically without the need for a clutch pedal especially complements a hybrid vehicle that is arranged to switch its engine off when stationary or being driven solely by the electric motor, since the user does not need to concern himself with operating the clutch in such situations.

The techniques described above are not limited to use in vehicles, but could be employed in stationary hybrid drive systems.

The control unit 10 could be implemented as a digital processor that process the inputs it receives and generates outputs in response thereto based on software stored in the control unit. The control unit 10 could be a unitary device or could be distributed as two or more devices. The control unit 10 could initiate gear changes automatically without user-intervention based on a pre-stored control strategy.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A hybrid drive system comprising:
an internal combustion engine having a first output shaft;
an electric motor having a second output shaft coupled to the first output shaft, the electric motor being capable of operating in a drive mode to drive the second output shaft and in a regeneration mode to generate electricity from the motion of the second output shaft;
a gearbox having an input shaft coupled to the first and second output shafts and an output shaft coupleable to the input shaft in any of two or more gear ratios;
a control unit arranged to control the electric motor during the changing of the gearbox from one of the two or more gear ratios to other of the two or more gear ratios so as to alter the speed of the input shaft so as to match that of the output shaft for the other gear ratio.

2. The hybrid drive system according to claim 1, wherein the control unit is arranged to: when the electric motor is not operating in the regeneration mode at the start of the changing of the gearbox from the one gear ratio to the other gear ratio, and the other gear ratio is one for which the speed of the input shaft is lower for a given speed of the third output shaft than in the one gear ratio, cause the electric motor to enter the regeneration mode during the changing of the gearbox from the one gear ratio to the other gear ratio so as to reduce the speed of the input shaft so as to match that of the output shaft for the other gear ratio.

3. The hybrid drive system according to claim 1, wherein the control unit is arranged to: when the electric motor is not operating in the drive mode at the start of the changing of the gearbox from the one gear ratio to the other gear ratio, and the other gear ratio is one for which the speed of the input shaft is higher for a given speed of the third output shaft than in the one gear ratio, cause the electric motor to enter the drive mode during the changing of the gearbox from the one gear ratio to the other gear ratio so as to increase the speed of the input shaft so as to match that of the output shaft for the other gear ratio.

4. The hybrid drive system according to claim 1, wherein the gearbox is manually operable to change from the one gear ratio to the other gear ratio.

5. The hybrid drive system according to claim 4, wherein upon manual disengagement of the one gear ratio, the control unit is arranged to make an estimate of the other gear ratio that will be engaged next and to control the electric motor during the changing of the gearbox from the one gear ratio to the other gear ratio so as to alter the speed of the input shaft so as to match that of the output shaft for the estimated gear ratio.

6. The hybrid drive system according to claim 1, wherein the control unit is capable of automatically operating the gearbox to change from the one gear ratio to the other gear ratio.

7. The hybrid drive system according to claim 1, further comprising a clutch for disconnecting the input shaft of the gearbox from the first and second output shafts, wherein the control unit is capable of automatically operating the clutch to disconnect the input shaft of the gearbox from the first and second output shafts.

8. The hybrid drive system according to claim 1, wherein the control unit is arranged to control the power output of the engine during the changing of the gearbox from the one gear ratio to the other gear ratio so as to alter the speed of the input shaft so as to match that of the output shaft for the other gear ratio.

9. A vehicle, comprising:
an internal combustion engine having a first output shaft:
an electric motor having a second output shaft coupled to the first output shaft, the electric motor being capable of operating in a drive mode to drive the second output shaft and in a regeneration mode to generate electricity from the motion of the second output shaft;
a gearbox having an input shaft coupled to the first and second output shafts and an output shaft coupleable to the input shaft in any of two or more gear ratios;
a control unit arranged to control the electric motor during the changing of the gearbox from one of the two or more gear ratios to other of the two or more gear ratios so as to alter the speed of the input shaft so as to match that of the output shaft for the other gear ratio,
wherein the third output shaft is arranged for propulsion of the vehicle.

10. (canceled)
